(19) United States
(12) Patent Application Publication
(10) Pub. No.: US 2025/0191101 A1
(43) Pub. Date: Jun. 12, 2025

(54) DISPATCH MANAGEMENT DEVICE, DISPATCH MANAGEMENT METHOD, AND DISPATCH MANAGEMENT COMPUTER PROGRAM

(71) Applicant: TOYOTA JIDOSHA KABUSHIKI KAISHA, Toyota-shi Aichi-ken (JP)

(72) Inventor: Kenta Kumazaki, Bunkyo-ku Tokyo-to (JP)

(73) Assignee: TOYOTA JIDOSHA KABUSHIKI KAISHA, Toyota-shi Aichi-ken (JP)

(21) Appl. No.: 18/973,176

(22) Filed: Dec. 9, 2024

(30) Foreign Application Priority Data
Dec. 11, 2023 (JP) 2023-208512

(51) Int. Cl. G06Q 50/40

(52) U.S. Cl. CPC G06Q 50/40

(57) ABSTRACT

The dispatch managing device includes a memory configured to store, for each of a plurality of candidate vehicles that can be dispatched, a discomfort tolerance indicating an allowable degree of discomfort for the candidate vehicle; and a processor configured to determine a candidate vehicle whose discomfort tolerance is higher than a discomfort influence degree indicating a degree of influence on discomfort which a user may induce while the user gets on any one of the plurality of candidate vehicles as a vehicle to be dispatched to the user.

### CROSS-REFERENCE TO RELATED APPLICATIONS

This application claims priority to Japanese Patent Application No. 2023-208512 filed Dec. 11, 2023, the entire contents of which are herein incorporated by reference.

### FIELD

The present disclosure relates to a dispatch management device, a dispatch management method, and a dispatch management computer program for dispatching a vehicle.

### BACKGROUND

In a service in which the same vehicle is provided to an unspecified number of users, a technique for providing a vehicle in which the smell level in the vehicle satisfies a predetermined criterion has been proposed (see WO 2020/039223). The vehicle management system disclosed in WO 2020/039223 determines a type of in-vehicle odor based on in-vehicle odor data output from an odor sensor, acquires an odor level associated with the type of in-vehicle odor from the in-vehicle odor data, and determines whether or not the odor level satisfies a predetermined criterion.

### SUMMARY

Depending on a user using a vehicle to be dispatched, a degree of discomfort that the user may cause in the vehicle varies.

Accordingly, it is an object of the present disclosure is to provide a dispatch management device that can facilitate to dispatch a suitable vehicle for a degree of discomfort which a user may induce.

According to one aspect of the present disclosure, a dispatch management device is provided. The dispatch management device includes: a memory configured to store, for each of a plurality of candidate vehicles that can be dispatched, a discomfort tolerance indicating an allowable degree of discomfort for the candidate vehicle; and a processor configured to determine a candidate vehicle whose discomfort tolerance is higher than a discomfort influence degree indicating a degree of influence on discomfort which a user may induce while the user gets on any one of the plurality of candidate vehicles as a vehicle to be dispatched to the user.

In one embodiment, the processor is further configured to update the discomfort influence degree of the user based on a behavior of the user while the user gets on any one of the plurality of candidate vehicles.

In one embodiment, the processor updates the discomfort influence degree based on a degree of odor generated by the user, presence or absence of smoking by the user, or presence or absence of eating and drinking by the user when the user gets on any one of the plurality of candidate vehicles.

According to another embodiment, a dispatch management method is provided. The dispatch management method includes: determining, among a plurality of candidate vehicles that can be dispatched, a candidate vehicle whose discomfort tolerance indicating an allowable degree of discomfort for the candidate vehicle is higher than a discomfort influence degree indicating a degree of influence on discomfort which a user may induce while the user gets on any one of the plurality of candidate vehicles as a vehicle to be dispatched to the user.

According to still another embodiment, a non-transitory recording medium that stores a dispatch management computer program is provided. The dispatch management computer program includes instructions causing a computer to execute a process including: determining, among a plurality of candidate vehicles that can be dispatched, a candidate vehicle whose discomfort tolerance indicating an allowable degree of discomfort for the candidate vehicle is higher than a discomfort influence degree indicating a degree of influence on discomfort which a user may induce while the user gets on any one of the plurality of candidate vehicles as a vehicle to be dispatched to the user.

The dispatch management device according to the present disclosure has an effect of being able to facilitate to dispatch a suitable vehicle for a degree of discomfort which a user may induce.

### BRIEF DESCRIPTION OF DRAWINGS

FIG. 1 is a schematic configuration diagram of a dispatch management system in which a dispatch management device according to an embodiment is implemented.

FIG. 2 is a schematic configuration diagram of a server, which is an example of a dispatch management device.

FIG. 3 is a functional block diagram of a processor of a server related to a dispatch management process.

FIG. 4 is a diagram for explaining an outline of determination of a vehicle to be dispatched according to the present embodiment.

FIG. 5 is an operation flowchart of the dispatch management process.

### DESCRIPTION OF EMBODIMENTS

Hereinafter, a dispatch management device, a dispatch management method, a computer program for dispatch management, and a dispatch management system including the dispatch management device will be described with reference to the drawings. For each of the plurality of candidate vehicles that can be dispatched in response to a dispatch request of a user, the dispatch management device compares discomfort tolerance indicating a degree of discomfort for the candidate vehicle with a discomfort influence degree indicating a degree of influence on the degree of discomfort which the user may induce while riding on the vehicle. The dispatch management device determines, among the candidate vehicles, a candidate vehicle having a higher degree of discomfort tolerance than the discomfort influence degree as a vehicle to be dispatched to the user.

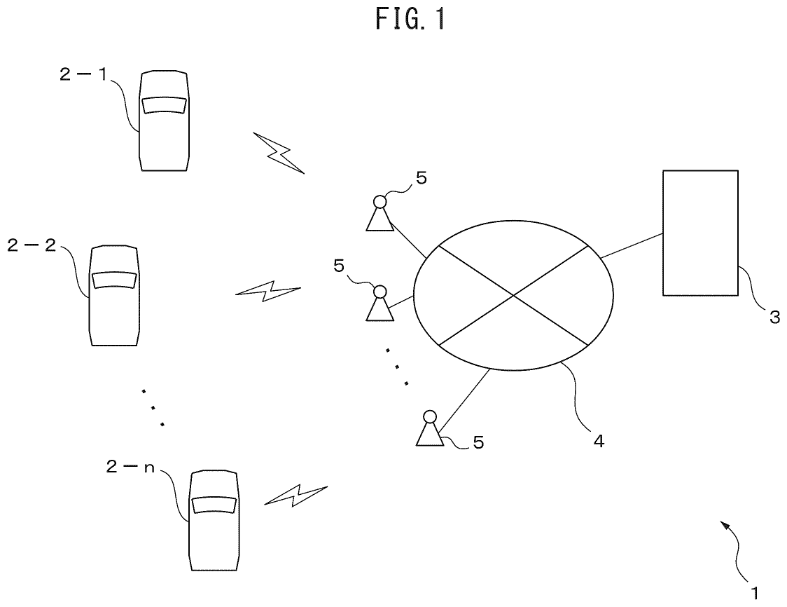

FIG. 1 is a schematic configuration diagram of a dispatch management system 1 in which a dispatch management device according to an embodiment is implemented. The vehicle dispatch management system 1 includes a plurality of vehicles 2-1 to 2-n that can be dispatched (n is an integer of 2 or more), and a server 3 that is an example of the dispatch management device. Each of the plurality of vehicles 2-1 to 2-n can communicate with the server 3 via a communication network 4 and a wireless base station 5 connected to the communication network 4 via a gateway (not shown). The server 3 is connected to the communication network 4 via, for example, a gateway (not shown). The server 3 determines a vehicle to be dispatched from among the plurality of vehicles 2-1 to 2-n in response to a dispatch request from the user and transmits a pick-up instruction to the determined vehicle.

The dispatch management system 1 may further include one or more mobile terminals (not shown) capable of communicating with the server 3 via the wireless base station 5 and the communication network 4. Such a mobile terminal may be, for example, a mobile phone carried by a user. Then, the mobile terminal transmits a dispatch request including identification information of the user and information indicating a planned boarding location of the user to the server 3 via the wireless base station 5 and the communication network 4, in accordance with the user's operation. The server 3 may be connected to a user information server (not shown) that manages user information via the communication network 4. In this case, the server 3 may receive the dispatch request from the user information server via the communication network 4. Further, the server 3 may be connected to a weather information server (not shown) that distributes weather information representing weather in each place via the communication network 4. The server 3 may then receive weather information from the weather information server via the communication network 4.

The dispatch request may further include information indicating at least one of a scheduled boarding date and time of the user, a planned getting-out location of the user, a planned traveling route from the planned boarding location to the planned getting-out location, an expected number of passengers, a desired vehicle type, and a desired option.

Each of the plurality of vehicles 2-1 to 2-n may be a vehicle capable of providing a mobility service such as a taxi service, and may be an autonomous vehicle. To this end, each of the plurality of vehicles 2-1 to 2-n includes, for example, a wireless communication terminal (not shown), an electronic control unit (ECU, not shown), and a positioning device (not shown). The wireless communication terminal has a wireless communication function and is configured to be able to communicate with the wireless base station 5. The ECU controls autonomous driving of the vehicle and controls each unit of the vehicle. The positioning device is configured to measure the position of the vehicle and may include, for example, a receiver for receiving a Global Positioning System (GPS) signal and computing circuitry for calculating the position of the vehicle from GPS signals. Further, each of the plurality of vehicles 2-1 to 2-n may include a storage device (not shown) for storing map information, and a navigation system (not shown) for determining a traveling route from the present position of the vehicle to the travel destination. Furthermore, each of the plurality of vehicles 2-1 to 2-n may have an external sensor (not shown) for obtaining information about the surroundings of the vehicle. The external sensor may be, for example, a camera provided to capture an image of the surroundings of the vehicle, or a ranging sensor such as a radar or a LiDAR sensor for detecting a distance to an object present around the vehicle. Furthermore, each of the plurality of vehicles 2-1 to 2-n may include an in-vehicle camera provided to capture an image of an inside of the vehicle, and an odor sensor for detecting an odor in the vehicle. The wireless communication terminal, the positioning device, the storage device, the navigation system, the external sensor, the in-vehicle camera, and the odor sensor are communicably connected to the ECU via an in-vehicle network (not shown) compliant with a predetermined standard such as a Controller Area Network (CAN) provided in the vehicle.

In each of the plurality of vehicles 2-1 to 2-n, when a pick-up instruction is notified from the server 3 via the wireless communication terminal, the ECU returns a signal indicating that the pick-up instruction has been received to the server 3 via the wireless communication terminal. In a case where the pick-up request cannot be fulfilled, such as a case where the remaining fuel or the remaining capacity of the battery of the vehicle that has received the pick-up instruction is less than the predetermined lower limit threshold, the ECU may return a signal indicating that fulfilling of the pick-up is impossible to the server 3 via the wireless communication terminal. In addition, the ECU notifies the navigation system of the planned boarding location designated by the pick-up instruction when there is no reason to be unable to fulfill the pick-up instruction. Then, the navigation system refers to the map information and searches a traveling route from the current position of the vehicle measured by the positioning device to the planned boarding location. Similarly, when the user gets into the vehicle at the notified planned boarding location, the navigation system refers to the map information and searches a traveling route from the planned boarding location to the planned getting-out location of the user. Then, the navigation system notifies the ECU of the determined traveling route. The ECU executes autonomous driving control of the vehicle so that the vehicle moves to the planned boarding location or the planned getting-out location along the traveling route. At this time, the ECU may control the velocity of the vehicle so that the distance from other objects existing around the vehicle is maintained at a predetermined value or more by using the information about the vehicle surroundings obtained by the external sensor. When the planned traveling route is included in the pick-up instruction received from the server 3, the ECU may execute autonomous driving control of the vehicle so that the vehicle moves to the planned boarding location or the planned getting-out location along the planned traveling route included in the pick-up instruction. Further, the ECU transmits the present position of the vehicle measured by the positioning device, together with the identification information of the vehicle, to the server 3 via the wireless communication terminals at predetermined intervals (for example, 30 seconds, 1 minute, or 5 minutes). Furthermore, when the ECU detects that the user has gotten in the vehicle at the planned boarding location notified from the server 3, the ECU transmits a signal indicating that the user has gotten in the vehicle, a position of the vehicle when the user has boarded measured by the positioning device, and a time obtained from an in-vehicle clock (not shown) when the user got in the vehicle to the server 3 via the wireless communication terminal. Similarly, when ECU detects that the user getting out of the vehicle, the ECU transmits a signal indicating that the user has gotten out of the vehicle, a position of the vehicle measured by the positioning device and a time obtained from the in-vehicle clock when the user got out of the vehicle to the server 3 via the wireless communication terminal together with the identification information of the vehicle. Note that when the ECU detects that the door of the vehicle has been opened at the planned boarding location by an opening/closing sensor (not shown) of the door, the ECU determines that the user has gotten in the vehicle. Similarly, the ECU determines that the user has gotten out of the vehicle when the door opening/closing sensor detects that the door of the vehicle has been opened at the planned getting out location of the user who is getting on the vehicle. The ECU may detect that the user gets into or gets out of the vehicle based on a sensor signal obtained by another sensor provided in a passenger compartment of the vehicle, such as a camera for monitoring the passenger compartment or a seating sensor.

In addition, the ECU determines influence information indicating influence on a degree of discomfort based on behavior of a user while the user is riding. To this end, the ECU calculates a difference between an average value of an intensity of the odor represented by the sensor signal detected by the odor sensor while the user is riding and the average value of the intensity of the odor represented by the sensor signal detected by the odor sensor during a predetermined time period before the user rides as an odor index value representing the intensity of the odor emitted by the user. Further, the ECU determines whether the user has smoked and whether the user has eaten or drank based on the series of in-vehicle images generated by the in-vehicle camera during the ride. For example, the ECU detects that the user has performed the smoking behavior or the eating and drinking behavior by inputting in-vehicle images in chronological order to a classifier trained in advance so as to detect the smoking behavior and the eating and drinking behavior. As such a classifier, a neural network including a recursive structure such as a recurrent neural network is used. After the user got out of the vehicle, the ECU transmits the influence information including the odor index value, the determination result of whether the user has smoked or not, and whether the user has eaten or drank, to the server 3 via the wireless communication terminal together with the identification information of the user.

Note that each of the plurality of vehicles 2-1 to 2-n may be a vehicle that is manually driven by a driver.

The server 3 selects one or more candidate vehicles from among the plurality of vehicles 2-1 to 2-n in response to the received dispatch request. Then, the server 3 determines a vehicle to be dispatched from among the candidate vehicles based on the discomfort tolerance of each candidate vehicle and the discomfort influence degree of the user, and transmits a pick-up instruction to the determined vehicle via the communication network 4 and the wireless base station 5.

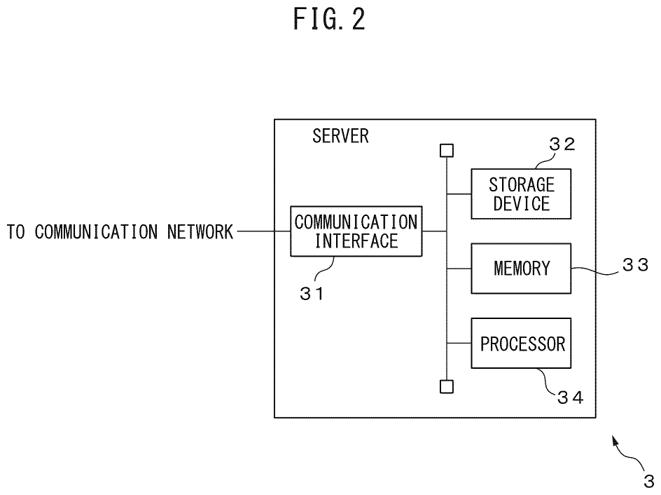

FIG. 2 is a schematic configuration diagram of the server 3, which is an example of the dispatch management device. The server 3 includes a communication interface 31, a storage device 32, a memory 33, and a processor 34. The communication interface 31, the storage device 32, and the memory 33 are connected to the processor 34 via a signal line.

The communication interface 31 is an example of a communication unit, and includes an interface circuit for connecting the server 3 to the communication network 4. The communication interface 31 is configured to be able to communicate with respective wireless communication terminals of a plurality of vehicles 2-1 to 2-n and a mobile terminal carried by a user via the communication network 4 and the wireless base station 5. The communication interface 31 is also configured to be able to communicate with a user information server and a weather information server via the communication network 4. Then, the communication interface 31 passes a signal which is received from the wireless communication terminal of any vehicle via the wireless base station 5 and the communication network 4 and represents the current position of the vehicle etc., to the processor 34. In addition, the communication interface 31 passes a dispatch request received from the mobile terminal or the user management server via the communication network 4 (and the wireless base station 5) to the processor 34. Further, the communication interface 31 passes weather information received from the weather information server via the communication network 4 to the processor 34. Furthermore, the communication interface 31 transmits a pick-up instruction to a designated vehicle received from the processor 34 to the vehicle via the communication network 4 and the wireless base station 5.

The storage device 32 is an example of a storage unit and includes, for example, a Solid State Drive (SSD). The storage device 32 may include a hard disk device, an optical recording medium, and an access device thereof. The storage device 32 stores vehicle information for each of the vehicles 2-1 to 2-n. The vehicle information includes identification information of the vehicle, a type of the vehicle, an uncomfortable tolerance of the vehicle, a current position of the vehicle, presence or absence of various optional equipment, and a state flag indicating a service providing state (for example, in a standby state, in a pick-up state, or in a user ride state). The storage device 32 also stores map information. Further, the storage apparatus 32 stores, for each of the registered users, identification information of the user and a discomfort influence degree of the user. Furthermore, the storage device 32 may store a computer program for executing the dispatch management process.

The discomfort tolerance of each vehicle is set in advance in accordance with an upper limit of an allowable smell intensity in the vehicle, whether smoking in the vehicle is permitted, whether eating and drinking in the vehicle is permitted, and a degree of dirt on the seat or the foot. In general, the discomfort tolerance is set lower as the luxury vehicle or the new vehicle. For example, the discomfort tolerance Dt is set according to the following equation:

$$Dt = w 1 * so + w 2 * sm + w 3 * ed + w 4 * dd \qquad ( 1 )$$

Herein, the parameter so, sm, ed, dd is an index value representing an upper limit of an allowable smell intensity in the vehicle, whether smoking in the vehicle is permitted, whether eating and drinking in the vehicle is permitted, and a degree of dirt on the seat or the foot. Each of the parameters w1 to w4 is a weighting factor for the index so, sm, ed, dd, and is set in advance. The higher the upper limit of the allowable smell intensity in the vehicle, the higher the index value so is set. Also, the index value sm is set such that the value when smoking is not permitted is lower than the value when smoking is permitted. Similarly, the index value ed is set such that the value when eating and drinking are not permitted is lower than the value when eating and drinking are permitted. Further, the index value dd is set to a higher value as the stain on the seat or the foot becomes severe. These index values are set by the provider providing the mobility service which confirms the state of each vehicle. When indices of any of the vehicles are inputted through a user interface (not shown), the processor 34 automatically calculates the discomfort tolerance Dt. Alternatively, the discomfort tolerance Dt which has been calculated according to equation (1) may be inputted via the user interface together with the identification number of any of the vehicles. The processor 34 then stores the discomfort tolerance Dt in the storage device 32 in association with the identification number of the vehicle. It should be noted that all of the above-described indices may not be considered in the setting of the discomfort tolerance, and the discomfort tolerance may be set based on any one to three of these indices. In this case, the weighting factor corresponding to the index that is not considered may be set to 0. Further, in setting the discomfort tolerance, an index related to the degree of discomfort other than the above-described index may be considered.

The discomfort tolerance of each of the vehicles 2-1 to 2-n may be reset periodically or irregularly depending on the state of use or the service period of the vehicle so far. For example, the discomfort tolerance is set to be higher as the total travel distance of the vehicle 2-k (k=1, 2, . . . , n) increases, as the number of days elapsed from the manufacturing date or the registration date increases, or as the number of years elapsed since the provision to the mobility service is started increases. Further, the discomfort tolerance may be set to be higher as the total travel distance becomes longer than the average value of the total travel distances of the vehicles 2-1 to the vehicle 2-n or as the elapsed days become longer than the average value of the elapsed days from the manufacturing date or the registration date.

Specifically, until the number of years elapsed from the date of manufacture or the date of registration reaches a predetermined period (e.g., 3 to 5 years), the index values sm and ed are set to a relatively lower value indicating that smoking and eating and drinking are not permitted, respectively. On the other hand, when the elapsed number of years exceeds the predetermined period, the index values sm and ed are set to relatively a higher value indicating that smoking and eating and drinking are permitted, respectively. In addition, the index value so is set to a large value as the number of years elapsed from the manufacturing date or the registered date increases. Similarly, when the total travel distance is less than a predetermined distance (e.g., tens of thousands of km to 0.1 million km), the index values sm and ed are set to a relatively lower value indicating that smoking and eating are not permitted, respectively. On the other hand, when the total travel distance exceeds the predetermined distance, the index values sm and ed are set to a relatively higher value indicating that smoking and eating and drinking are permitted, respectively. Further, the index value so is set to a larger value as the total travel distance becomes longer. Accordingly, among the vehicles 2-1 to 2-n, the older the vehicle, the easier the dispatch of the vehicle to the user who has a higher degree of discomfort influence, and conversely, the less the dispatch of the vehicle to the user who has a lower degree of discomfort influence. As a result, a relatively new vehicle is more likely to be dispatched to a user with a low degree of discomfort influence.

After the user got out from any of the vehicles 2-1 to 2-n, the user's discomfort influence degree is updated based on the influence information received from the vehicle. Details of the calculation of the discomfort influence degree will be described later.

The memory 33 is another example of a storage unit, and includes, for example, a nonvolatile semiconductor memory and a volatile semiconductor memory. The memory 33 stores various data generated during the execution of the dispatch management process, various data received from other devices, and the like.

The processor 34 is an exemplary controller and includes one or more Central Processing Units (CPUs) and peripheral circuitry thereof. The processor 34 may further include other arithmetic circuits such as a logical arithmetic unit or a numerical arithmetic unit. Each time weather information is received from the weather information server, the processor 34 stores the received weather information in the memory 33 or the storage device 32. When the processor 34 receives the information or the effect information indicating the current position of the vehicle from any of the plurality of vehicles 2-1 to 2-n, it stores the current position or the influence information of the vehicle together with the identification information of the vehicle in the storage device 32. Further, the processor 34 transmits a pick-up request to any vehicle, and upon receiving a signal indicating that a pick-up request has been received from the vehicle, updates the value of the state flag of the vehicle to a value indicating that the vehicle is picking up. Further, when the processor 34 receives a signal indicating that the user has ridden from any of the plurality of vehicles 2-1 to 2-n, it updates the value of the status flag of the vehicle to a value indicating that the user is riding. Similarly, when the processor 34 receives a signal from any of the plurality of vehicles 2-1 to 2-n indicating that the user has got off, it updates the value of the status flag of the vehicle to a value indicating that the vehicle is waiting. Further, upon receiving the dispatch request, the processor 34 executes the dispatch management process.

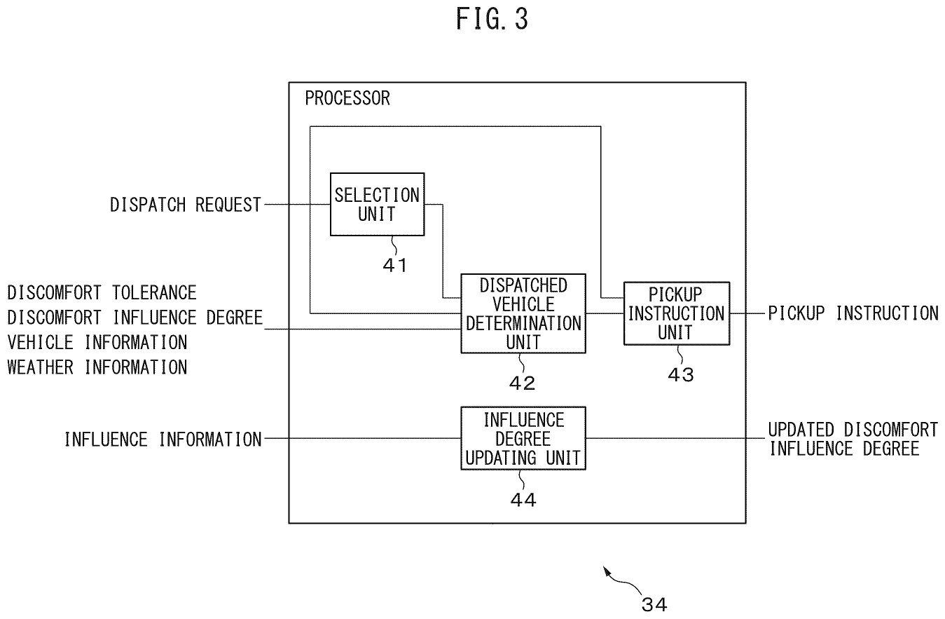

FIG. 3 is a functional block diagram of the processor 34 associated with the dispatch management process. The processor 34 includes a selection unit 41, a dispatched vehicle determination unit 42, a pick-up instruction unit 43, and an influence degree update unit 44. Each of these units included in the processor 34 is, for example, a functional module realized by a computer program running on the processor 34. Alternatively, each of these units may be a dedicated arithmetic circuit provided in the processor 34.

When the server 3 receives the dispatch request, the selection unit 41 selects one or more vehicles capable of satisfying the dispatch request from among the vehicles 2-1 to 2-n as the candidate vehicles. For this purpose, the selection unit 41 refers to the state flags of the respective vehicles and identifies each vehicle of which the value of the state flags identifies the standby state. Further, the selection unit 41 selects, as a candidate vehicle, one or more vehicles that can move to the planned boarding location designated by the dispatch request within a predetermined time (for example, within 10 minutes or within 15 minutes) from among the identified vehicles. For this purpose, the selection unit 41 refers to the map information to search for a route from the current position of the vehicle to the planned boarding location by a predetermined route searching method such as the Dijkstra method, and predicts a time required to move to the planned boarding location based on the searched route. The selection unit 41 selects, as a candidate vehicle, a vehicle whose predicted required time is equal to or less than a predetermined time from among the identified vehicles. In a case where the scheduled boarding date and time is included in the dispatch request, the selection unit 41 may select, as a candidate vehicle, a vehicle whose predicted required time is shorter than the period from the current time to the scheduled boarding date and time from among the identified vehicles. In addition, in a case where the expected number of passengers is included in the dispatch request, the selection unit 41 excludes each vehicle whose occupant capacity is smaller than the expected number of passengers from the candidate vehicles.

The selection unit 41 notifies the dispatched vehicle determination unit 42 of the identification information of each candidate vehicle.

The dispatch vehicle determination unit 42 determines a vehicle to be dispatched from among the candidate vehicles based on the discomfort tolerance set for each candidate vehicle and the discomfort influence degree of the user. In the present embodiment, the dispatched vehicle determination unit 42 determines one of the candidate vehicles whose discomfort tolerance is higher than the discomfort influence degree among the candidate vehicles as the vehicle to be dispatched. When the user is already registered, the dispatched vehicle determination unit 42 uses the discomfort influence degree of the user stored in the storage device 32 for comparison with the discomfort tolerance. When the user is unregistered, the dispatched vehicle determination unit 42 uses the initial value of the discomfort influence degree for comparison with the discomfort tolerance.

The vehicle dispatch determining unit 42 may correct the value of the discomfort influence degree based on the planned boarding location and the scheduled boarding date and time specified in the dispatch request. The dispatched vehicle determination unit 42 may use the corrected value of the degree of discomfort effect for comparison with the discomfort tolerance of each candidate vehicle. For example, when there is a place where some strong odor is likely to be generated around the boarding location of the user (hereinafter, referred to as an odor generation position), the odor inside the vehicle may be strong. Therefore, the dispatched vehicle determination unit 42 adds a predetermined value to the discomfort influence degree. Thus, the dispatch vehicle determination unit 42 may determine whether or not there is such an odor generation position within a predetermined distance (for example, about several 10 m) from the planned boarding location by referring to the planned boarding location of the user and the map information. Note that the odor generation position is, for example, a sea bathing place, a mountain climbing entrance, or the like. In addition, the predetermined value may be set to a larger value as the odor at the odor generation position is stronger. Further, the dispatched vehicle determination unit 42 may predict the weather around the vehicle when the user gets into the dispatched vehicle by referring to the planned boarding location, the scheduled boarding date and time, and the weather information received from the weather information server. When the predicted weather around the vehicle at the time of boarding is a bad weather such as rain or snow, the dispatch vehicle determination unit 42 may add a predetermined value to the discomfort influence degree because the degree of discomfort may increase due to wetting of the seat or the like when the user gets into the vehicle.

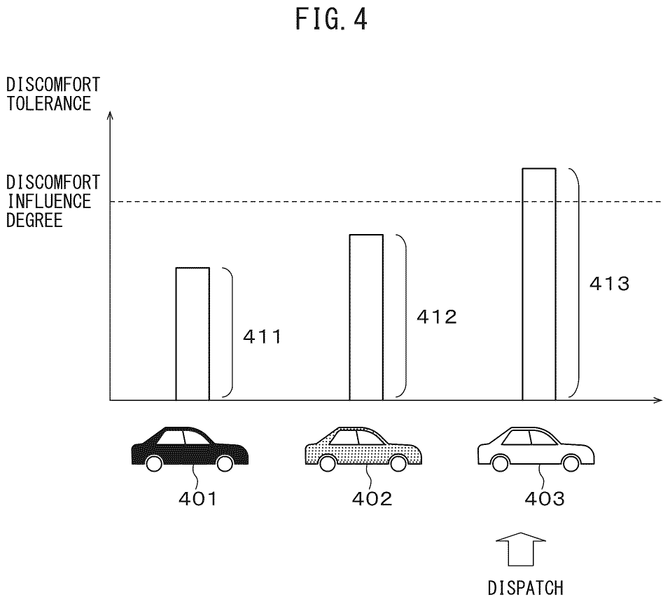

FIG. 4 is a diagram for explaining an outline of determination of a vehicle to be dispatched according to the present embodiment. In the example illustrated in FIG. 4, it is assumed that there are three candidate vehicles 401, 402, and 403. In addition, in FIG. 4, the vertical axis represents the discomfort tolerance, and the respective discomfort tolerances 411 to 413 of the candidate vehicles 401 to 403 are shown. In this example, when the discomfort influence degree of the user who made the dispatch request is compared with the discomfort tolerance of each candidate vehicle, the discomfort tolerance 413 of the candidate vehicle 403 exceeds the discomfort influence degree, but the discomfort tolerance 411 of the candidate vehicle 401 and the discomfort tolerance 412 of the candidate vehicle 402 are lower than the discomfort influence degree. Therefore, the candidate vehicle 403 is selected as the vehicle to be dispatched.

In a case where there are a plurality of candidate vehicles whose discomfort tolerance is higher than the discomfort influence degree, the dispatched vehicle determination unit 42 may determine any of these candidate vehicles as the vehicle to be dispatched. Alternatively, the dispatch vehicle determination unit 42 may set the priority for each of the plurality of candidate vehicles whose discomfort tolerance is higher than the discomfort influence degree, in accordance with at least one item among the desired vehicle type, the presence or absence of the desired option, and the required time to the planned boarding location included in the dispatch request. The dispatch vehicle determination unit 42 may determine the candidate vehicle having the highest priority among the candidate vehicles having the discomfort tolerance higher than the discomfort influence degree as the vehicle to be dispatched.

For example, in a case where the desired vehicle type is included in the dispatch request, the dispatch vehicle determination unit 42 refers to the vehicle information of each candidate vehicle and sets a priority level related to the desired vehicle type for each candidate vehicle. For example, the dispatched vehicle determination unit 42 sets the priority regarding the desired vehicle type for each candidate vehicle so that the priority for the candidate vehicle of the same vehicle type as the desired vehicle type is higher than the priority for the candidate vehicle of a different vehicle type from the desired vehicle type. Similarly, when the desired option is included in the dispatch request, the dispatch vehicle determination unit 42 refers to the vehicle information of each candidate vehicle, and sets the priority regarding the desired option for each candidate vehicle. For example, the dispatched vehicle determination unit 42 sets the priority for the desired option for each candidate vehicle so that the priority for the candidate vehicle having the desired option is higher than the priority for the candidate vehicle that does not have the desired option. Further, the dispatched vehicle determination unit 42 sets a priority regarding the required time for each candidate vehicle so that the priority becomes higher as the required time to the planned boarding location is shorter.

The vehicle dispatch determination unit 42 sets, for each candidate vehicle, the weighted sum of the priorities obtained for the individual items as the priority of the candidate vehicle. The weight coefficient of each item may be set in advance.

The dispatch vehicle determination unit 42 notifies the pick-up instruction unit 43 of the identification information of the vehicle to be dispatched.

The pickup instruction unit 43 generates a pick-up instruction including the planned boarding location included in the dispatch request for the vehicle specified by the identification information notified from the dispatched vehicle determination unit 42. The pickup instruction unit 43 transmits the generated pick-up instruction to the vehicle to be dispatched via the communication interface 31, the communication network 4, and the wireless base station 5. Note that the pick-up instruction may include identification information of the user who has transmitted the dispatch request, a planned getting-out location of the user, and information indicating a planned traveling route.

The influence degree updating unit 44 updates the discomfort influence degree of the user based on the behavior of the user while in any one of the vehicles 2-1 to 2-n. In the present embodiment, the influence degree updating unit 44 updates the discomfort influence degree of the user based on the influence information received from the vehicle on which the user has ridden. For example, the discomfort influence degree Di is set according to the following equation.

$$Di = x 1 * uso + x 2 * usm + x 3 * ued \qquad ( 2 )$$

Hereing, each parameter uso, usm, ued is an index value indicating an odor index value, the presence or absence of smoking, and the presence or absence of eating or drinking when the use has ridden on any vehicle in the past. Each of the parameters x1 to x3 is a weighting factor for the index uso, usm, ued, and is set in advance. The influence degree updating unit 44 sets the odor index value included in the influence information received from the vehicle on which the user has ridden as the index value uso. Therefore, the higher the odor index value, the higher the index value uso. The index value usm is set such that a value indicating that no smoking behavior is detected is lower than a value indicating that a smoking behavior of the user is detected. Similarly, the index value ued is set such that a value indicating that the eating and drinking behavior is not detected is lower than a value indicating that the eating and drinking behavior of the user is detected. It should be noted that all of the odor index value, the presence or absence of smoking, and the presence or absence of eating and drinking may not be taken into consideration for updating the degree of discomfort effect, and the discomfort influence degree may be updated based on any one or two of these indices. In this case, the weighting factor corresponding to the index that is not considered may be set to 0. Further, a behavior of the user that affects the degree of discomfort other than the above-described indications may be taken into account in updating the discomfort influence degree.

The influence degree updating unit 44 sets the discomfort influence degree calculated according to equation (2) as the updated discomfort influence degree.

When the user has ridden the vehicles 2-1 to 2-n a plurality of times, the influence degree updating unit 44 may set the mean of the discomfort influence degrees calculated according to equation (2) every time the user rides the vehicle as the updated discomfort influence degree. Alternatively, each time the user rides on any one of the vehicles 2-1 to 2-n, the influence degree updating unit 44 may calculate the updated discomfort influence degree by averaging the discomfort influence degree calculated according to equation (2) and the discomfort influence degree stored so far in the storage device 32 by using a predetermined forgetting coefficient.

The influence degree updating unit 44 stores the updated discomfort influence degree in the storage apparatus 32 in association with the identification information of the user included in the influence information received last for the user.

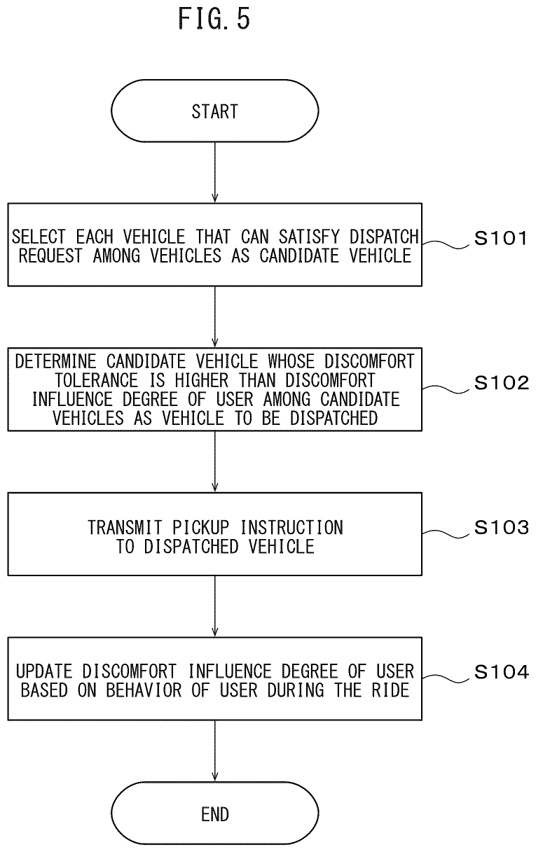

FIG. 5 is an operation flowchart of the dispatch management process. Each time the dispatch request is received, the processor 34 executes the dispatch management process according to the operation flowchart shown below.

The selection unit 41 selects one or more vehicles that can satisfy the dispatch request from among the plurality of vehicles 2-1 to 2-n as candidate vehicles (step S101). The vehicle dispatch determining unit 42 determines, as the vehicle to be dispatched, the candidate vehicle whose discomfort tolerance is higher than the discomfort influence degree of the user among the candidate vehicles (step S102). Then, the pickup instruction unit 43 transmits a pick-up instruction to the vehicles to be dispatched via the communication network 4 or the like (step S103).

After the user got out of the dispatched vehicle, the influence degree updating unit 44 updates the user's discomfort influence degree based on the behavior of the user while in the vehicle (step S104). Then, the processor 34 terminates the dispatch management process.

As described above, the dispatch management device compares a discomfort tolerance set in each of a plurality of candidate vehicles that can be dispatched to a dispatch request of a user with a discomfort influence degree of the user. The dispatch management device determines, among the candidate vehicles, a candidate vehicle whose discomfort tolerance is higher than the discomfort influence degree as a vehicle to be dispatched to the user. Therefore, the dispatch management device can determine a vehicle to be dispatched from among the candidate vehicles so that the suitable vehicle for the degree of discomfort which the user may induce is easily dispatched.

According to the modified example, the dispatched vehicle determination unit 42 may also set the result of comparison between the discomfort influence degree and the discomfort tolerance of each candidate vehicle as one of the items for calculating the priority. In this case, the dispatched vehicle determination unit 42 sets the priority for the candidate vehicle whose discomfort tolerance is higher than the discomfort influence degree of the user who has made the dispatch request, is higher than the priority for the candidate vehicle whose discomfort tolerance is equal to or lower than the discomfort influence degree. Then, the dispatch vehicle determination unit 42 may set the weighted sum of the priorities obtained for the individual items for each candidate vehicle as the priority of the candidate vehicle, and determine the candidate vehicle having the highest priority among the candidate vehicles as the vehicle to be dispatched.

The influence degree updating unit 44 may also use the location at which the user gets into and the date and time at which the user gets into to update the discomfort influence degree. In this case, the influence degree update unit 44 may execute the same processing as the correction of the discomfort influence degree based on the scheduled boarding date and time and the boarding location in the dispatched vehicle determination unit 42.

The computer program that causes the computer to execute the processing executed by the processor 34 of the server 3 may be distributed by being recorded on a recording medium such as an optical recording medium or a magnetic recording medium.

As described above, a skilled person can make various modifications according to the embodiment within the scope of the present disclosure.

What is claimed is:

1. A dispatch management device comprising:
a memory configured to store, for each of a plurality of candidate vehicles that can be dispatched, a discomfort tolerance indicating an allowable degree of discomfort for the candidate vehicle; and
a processor configured to determine a candidate vehicle whose discomfort tolerance is higher than a discomfort influence degree indicating a degree of influence on discomfort which a user may induce while the user gets on any one of the plurality of candidate vehicles as a vehicle to be dispatched to the user.

2. The dispatch management device according to claim 1, wherein the processor is further configured to update the discomfort influence degree of the user based on a behavior of the user while the user gets on any one of the plurality of candidate vehicles.

3. The dispatch management device according to claim 2, wherein the processor updates the discomfort influence degree based on a degree of odor generated by the user, presence or absence of smoking by the user, or presence or absence of eating and drinking by the user when the user gets on any one of the plurality of candidate vehicles.

4. A dispatch management method comprising:
determining, among a plurality of candidate vehicles that can be dispatched, a candidate vehicle whose discomfort tolerance indicating an allowable degree of discomfort for the candidate vehicle is higher than a discomfort influence degree indicating a degree of influence on discomfort which a user may induce while the user gets on any one of the plurality of candidate vehicles as a vehicle to be dispatched to the user.

5. A non-transitory recording medium that stores a dispatch management computer program for causing a computer to execute a process comprising:
determining, among a plurality of candidate vehicles that can be dispatched, a candidate vehicle whose discomfort tolerance indicating an allowable degree of discomfort for the candidate vehicle is higher than a discomfort influence degree indicating a degree of influence on discomfort which a user may induce while the user gets on any one of the plurality of candidate vehicles as a vehicle to be dispatched to the user.
